(19) United States
(12) Patent Application Publication
(10) Pub. No.: US 2005/0275541 A1
(43) Pub. Date: Dec. 15, 2005

(54) Method and apparatus to perform remote monitoring

(76) Inventors: Uttam K. Sengupta, Portland, OR (US); Nikhil M. Deshpande, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/865,366

(22) Filed: Jun. 9, 2004

(51) Int. Cl. G08B 23/00

(52) U.S. Cl. 340/573.1; 340/502; 362/227

(57) ABSTRACT

Method and apparatus to perform remote monitoring are described.

### BACKGROUND

As the general population becomes older there may be an increased need for remote monitoring. For example, an aging adult may choose to live alone. The aging adult may be susceptible to an accident or illness that may incapacitate the person, thereby making them unable to request assistance. Consequently, there may be a need for improved techniques for a person to remotely monitor the health and physical status of another person.

### BRIEF DESCRIPTION OF THE DRAWINGS

FIG. 1 illustrates a block diagram of a system 100;

FIG. 2 illustrates a block diagram of a system 200;

FIG. 3 illustrates a processing logic 300; and

FIG. 4 illustrates a processing logic 400.

### DESCRIPTION OF SPECIFIC EMBODIMENTS

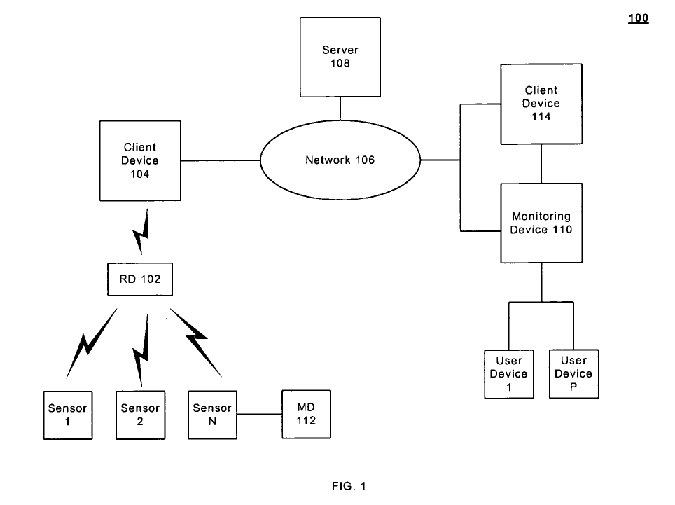

FIG. 1 illustrates a block diagram of a system 100. System 100 may comprise, for example, a communication system to communicate information between multiple nodes. The nodes may comprise any physical or logical entity having a unique address in system 100. The unique address may comprise, for example, a network address such as an Internet Protocol (IP) address, device address such as a Media Access Control (MAC) address, and so forth. The embodiments are not limited in this context.

The nodes may be connected by one or more types of communications media. The communications media may comprise any media capable of carrying information signals, such as metal leads, semiconductor material, twisted-pair wire, co-axial cable, fiber optics, radio frequency (RF) spectrum, and so forth. The connection may comprise, for example, a physical connection or logical connection.

The general architecture of system 100 may be implemented as a wired or wireless system. If implemented as a wireless system, one or more nodes shown in system 100 may further comprise additional components and interfaces suitable for communicating information signals over the designated RF spectrum. For example, a node of system 100 may include omni-directional antennas, wireless RF transceivers, control logic, and so forth. The embodiments are not limited in this context.

The nodes of system 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes may communicate the media and control information in accordance with one or more protocols. A protocol may comprise a set of predefined rules or instructions to control how the nodes communicate information between each other. The protocol may be defined by one or more protocol standards, such as the standards promulgated by the Internet Engineering Task Force (IETF), International Telecommunications Union (ITU), a company such as Intel® Corporation, and so forth.

Referring again to FIG. 1, system 100 may comprise a recording device 102 in wireless communication with multiple sensors 1-N. One or more of sensors 1-N may be connected to a motion detector 112. Recording device 102 may be in wireless communication with client device 104. Client device 104 may be connected to network 106. Server 108, monitoring device 110 and client device 114 may all be connected to network 106. Monitoring device 110 may also be connected to user devices 1-P and client device 114. Although system 100 comprises a limited number of nodes as shown in FIG. 1, it may be appreciated that system 100 may comprise any number of additional nodes in any number of different network topologies. The embodiments are not limited in this context.

In one embodiment, system 100 may include multiple sensors 1-N. Sensors 1-N may comprise any sensor capable of transmitting information signals. Sensors 1-N may be arranged to monitor a certain physical characteristic of the environment in which it is placed. For example, the physical characteristic might be the temperature, amount of light, or humidity of a room. Sensors 1-N may then transmit the collected information regarding the characteristic. Sensors 1-N may comprise, for example, passive or active radio frequency identification (RFID) tags. Passive RFID tags transmit a stream of information in response to an interrogation signal, such as an electromagnetic signal at a predetermined operating frequency. Passive RFID tags typically have no power source, and rely upon the energy delivered by the interrogation signal to transmit the stream of information. Active RFID tags may have a power source such as a direct current (DC) battery or power supply, or an alternating current (AC) power supply such as the power mains for a home or office. Active RFID tags may transmit a stream of information on a continuous basis, a periodic basis, or in response to some external event. Examples of an external event may include a signal from a human being, or a device such as motion detector 112 or a cell phone.

In one embodiment, sensors 1-N may be arranged to collect and transmit monitoring information. Monitoring information in this context may refer to any information regarding a sensor or the physical environment where the sensor is positioned. For example, monitoring information may include a temperature of a room, humidity for a room, amount of light in the room, and so forth. The monitoring information may also include usage of a device, such as an appliance, entertainment system, exercise equipment, telephone, computer, and so forth. The types and amounts of monitoring information may vary according to a given implementation, and the embodiments are not limited in this context.

In one embodiment, sensors 1-N may also be arranged to transmit information previously stored in memory. Examples of such stored information may include a location identifier, a name for the location, a unique identifier for the sensor, a date, a time, a clock signal, and so forth. The embodiments are not limited in this context.

In one embodiment, system 100 may include recording device 102. Recording device 102 may be any device capable of receiving the monitoring information from sensors 1-N. For example, recording device 102 may comprise an RFID reader to receive and store information from an RFID sensor. Recording device 102 may also include several monitoring sub-systems, such as a pedometer to measure movement, a heat sensor to measure body heat, a media recorder to record audio information, a voice activated microphone to activate the media recorder, a heart monitor, and so forth. Recording device 102 may have a form factor that allows a user to have recording device 102 in close proximity to the user on a consistent basis. For example, recording device 102 may be implemented as a watch, necklace, ring, eyeglass, and other unobtrusive forms that may be worn on the body of a monitored person. Recording device 102 may also have a wireless transceiver to communicate monitoring information to client device 104, and to receive information from client device 104 such as configuration or control information for recording device 102.

In one embodiment, system 100 may include client device 104. Client device 104 may comprise any processing system arranged to communicate monitoring information between recording device 102 and network 106. Examples of client device 104 may include a personal computer (PC), laptop computer, ultra-portable computer, handheld computer, cellular telephone, personal digital assistant (PDA), a wireless access point (WAP), and so forth. For example, client device 104 may comprise a PC having client application software. The client application software may be an agent for a monitoring service provider that is arranged to interact with server application software to provide monitoring services. The client application software may be arranged to perform a number of different client operations, such as subscribe to a monitoring service, receive configuration and control information for client device 104 and recording device 102, perform tests for various devices, perform authentication and encryption operations, send monitoring information to server 108 via network 106, and so forth. In standard operating mode, for example, client device 104 may periodically synchronize with recording device 102 and receive its monitoring information, open a data connection with server 108 via network 106, and communicate the monitoring information to server 108 or monitoring device 110. Similarly, server 108 may communicate control or configuration information to client device 104 and/or recording device 102 via network 106. The embodiments are not limited in this context.

In one embodiment, recording device 102 and client device 104 may communicate information in accordance with a number of different wireless protocols. Examples of such wireless protocols may include the 802.11 family of protocols, Bluetooth, Ultra Wide Band (UWB), and so forth. The embodiments are not limited in this context.

In one embodiment, system 100 may include network 106. Network 106 may comprise any type of network arranged to communicate information between the various nodes of system 100. For example, network 106 may comprise a packet data network such as a Local Area Network (LAN) or Wide Area Network (WAN), a Public Switched Telephone Network (PSTN), a wireless network such as cellular telephone network or satellite network, or any combination thereof. Network 106 may communicate information in accordance with any number of different data communication protocols, such as one or more Ethernet protocols, one or more Internet protocols such as the Transport Control Protocol (TCP) Internet Protocol (IP), Wireless Access Protocol (WAP), and so forth. The embodiments are not limited in this context.

In one embodiment, system 100 may comprise server 108. Server 108 may represent a single server, server farm, or other data storage infrastructure maintained by the monitoring service provider. Server 108 may include a server application program. The server application program may be arranged to interact with the client application program executed by client device 104. The server application program may perform a number of different server operations, such as account management operations, sending configuration and control information to client device 104 and recording device 102, perform authentication and encryption operations, receive monitoring information from client device 104, and so forth. The server application program may also be arranged to interact with monitoring device 110.

In one embodiment, system 100 may include monitoring device 110. Monitoring device 110 may comprise a device to receive monitoring information. Monitoring device 110 may receive the monitoring information from client device 104, server 108, or client device 114, depending upon a given implementation. For example, a monitoring service provider may desire all information to pass through server 108 for control or billing purposes. In another example, client device 104 may bypass server 108 and send the monitoring information directly to monitoring device 114. This may be useful in the event server 108 is inaccessible due to failure, maintenance or upgrades. In yet another example, client device 104 or server 108 may send the monitoring information to client device 114, and client device 114 may pass the monitoring information to monitoring device 110. In this example, client device 114 may communicate the monitoring information to monitoring device 110 using an 802.11 network. This may allow monitoring device 110 to be placed anywhere in the monitoring premises rather than limiting placement to near a wired network connection service port. This may also allow client device 114 to perform some of the more processor-intensive operations for monitoring device 110, such as analyzing the monitoring information to determine a current status level for the monitored person.

Once monitoring device 110 receives the monitoring information, monitoring device 110 may indicate a status level in accordance with the monitoring information. Since the monitoring information is intended to reflect the health or physical status of a person, monitoring device 110 may be considered an avatar for the person. An avatar may comprise a physical representation for a person or concept. The avatar may comprise any number of shapes or forms. Examples of an avatar may include a picture of a person to be monitored, a statue, a display with a visual representation of a person, and so forth. Monitoring device 110 may be implemented using, for example, a PC, laptop computer, ultra-portable computer, handheld computer, cellular telephone, PDA, a pager, and so forth.

In one embodiment, monitoring device 110 may receive monitoring information from server 108 via network 106. Monitoring device 110 may also receive monitoring information directly from client device 104. Monitoring device 110 may use the monitoring information to generate status information that allows a user to quickly assess the health or physical status of a monitored person.

In one embodiment, system 100 may include client device 114. Client device 114 may be similar to client device 104, except that it performs various administrative and maintenance operations on behalf of monitoring device 110 rather than recording device 102. For example, client device 114 may have client application software arranged to perform a number of different client operations, such as subscribe to a monitoring service, receive configuration and control information for monitoring device 110, perform authentication and encryption operations, assist in sending information to server 108 via network 106 or client device 104, and so forth. The embodiments are not limited in this context.

In one embodiment, system 100 may include user devices 1-P. User devices 1-P may include any communication device accessible by a user. Examples for user devices 1-P may include a telephone, a cellular telephone, a pager, a computer, a PDA, and so forth. If a user is not within visual or audible range of monitoring device 110, monitoring device 110 may send status or alert messages to the user via one or more user devices 1-P. For example, monitoring device 110 may be arranged to notify a user of any changes in status levels of the monitored person via email, voice message, voice mail, pager message, and so forth.

In general operation, system 100 may operate to allow a first person to remotely monitor a second person. The first person may also be referred to herein as the monitoring person or information consumer. The second person may also be referred to herein as the monitored person or information source. The remote monitoring could include monitoring the health or physical activity of the monitored person. For example, a network of sensors 1-N may be placed throughout an area to be monitored, such as a home or residence. A sensor may be placed in each room, for example, and may be configured to monitor various physical characteristics associated with the room. Assume the recording device 102 comprises a watch or a necklace that is worn by the monitored person. As the monitored person moves throughout the residence, recording device 102 receives monitoring information from the various sensors 1-N. Whenever the monitored person moves within communication range of client device 104, recording device 102 may send the collected monitoring information to client device 104 in a push model, or client device 104 may retrieve the collected monitoring information from recording device 102 in a pull model. A push or pull model may be implemented depending upon various factors, such as the power requirements associated with recording device 102, amount of processing power of recording device 102, and so forth. The monitoring information may be communicated between recording device 102 and client device 104 using, for example, the Bluetooth protocol, an 802.11 protocol, and so forth. Client device 104 may receive the monitoring information from recording device 102, and sends the monitoring information to server 108 via network 106. Server 108 may then forward the monitoring information to monitoring device 110. Alternatively, client device 104 may send the monitoring information directly to monitoring device 110, depending upon a given implementation.

Once monitoring device 110 receives the monitoring information, it may analyze the monitoring information to determine a status level for the monitored person. Monitoring device 110 may then indicate the status level to the monitoring person in the form of visual information, audio information, or a combination of visual and audio information. For example, monitoring device 110 may include a number of status indicators, such as Light Emitting Diodes (LED) arranged to display different colors. When the monitoring information indicates normal conditions for the monitored person, monitoring device 110 may display a green color, for example. When the monitoring information indicates unusual or atypical conditions for the monitored person, monitoring device 110 may issue an alert or change in status level by displaying a different color, causing the LED to flash, reproduce audio information such as voice, tone or beep, and so forth. There may be any number of predefined status levels depending upon a level of granularity needed for a given implementation. If the monitoring person does not acknowledge the alert within a certain time period, monitoring device 110 may send an alarm message to the monitoring person via one or more user devices 1-P, such as a cell phone or pager.

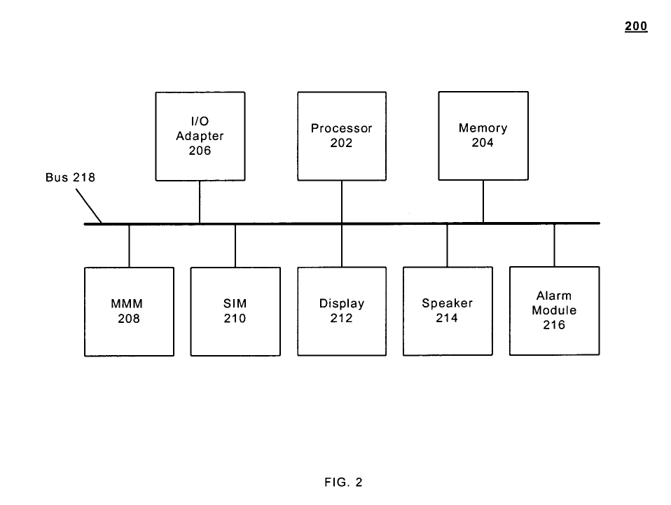

In this manner, system 100 allows the monitoring person to monitor the health or physical activity of a monitored person even while being physically remote from the monitored person. System 100 in general, and monitoring system 110 in particular, may be discussed in more detail with reference to FIGS. 2-4.

FIG. 2 illustrates a block diagram of a system 200. System 200 may be representative of a portion or all of the components used to implement any of the nodes in system 100. In one embodiment, system 200 may be representative of, for example, monitoring device 110 as described with reference to FIG. 1. Monitoring device 110, however, is not necessarily limited in this context.

As shown in FIG. 2, monitoring device 200 may comprise a processor 202, a memory 204, an Input/Output (I/O) adapter 206, a monitoring management module (MMM) 208, a status indicating module (SIM) 210, a display 212, a speaker 214, and an alarm module 216, all connected via a communication bus 218. Communication bus 218 may comprise any standard communication bus, such as a Peripheral Component Interconnect (PCI) bus, for example. The term “module” as used herein may refer to one or more circuits, components, registers, processors, software subroutines, or any combination thereof. Although FIG. 2 shows a limited number of elements, it can be appreciated that any number of elements may be used in monitoring device 200.

In one embodiment, monitoring device 200 may comprise processor 202. Processor 202 can be any type of processor capable of providing the speed and functionality desired for an embodiment. For example, processor 202 could be a processor made by Intel® Corporation and others. Processor 202 may also comprise a digital signal processor (DSP) and accompanying architecture. Processor 202 may further comprise a dedicated processor such as a network processor, embedded processor, micro-controller, controller and so forth. The embodiments are not limited in this context.

In one embodiment, monitoring system 200 may comprise memory 204. In one embodiment, memory 204 may comprise any machine-readable media capable of storing analog or digital information. Examples of machine-readable media may include read-only memory (ROM), random-access memory (RAM), programmable ROM, erasable programmable ROM, electronically erasable programmable ROM, dynamic RAM, magnetic disk such as a floppy disk and hard drive, optical disk such as a CD-ROM and Digital Video Disc (DVD), and any other media that may store analog or digital information. In one embodiment, the machine-readable media may store instructions and data adapted to be executed by a processor. The instructions may be stored on the media in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, system 200 may contain various combinations of machine-readable storage devices through various I/O controllers, which are accessible by processor 202 and which are capable of storing a combination of computer program instructions and data.

In one embodiment, monitoring device 200 may include I/O adapter 206. I/O adapter 206 may comprise a wired or wireless adapter depending upon a given implementation. In one embodiment, for example, network 106 may comprise a wired network. In this case, I/O adapter 206 may comprise a network adapter or network interface card (NIC) configured to operate with any suitable technique for controlling communication signals between computer or network devices using a desired set of communications protocols, services and operating procedures, for example. In one embodiment, I/O adapter 206 may operate, for example, in accordance with TCP/IP or Ethernet protocols, although the embodiments are not limited in this context. I/O adapter 206 also includes appropriate connectors for connecting I/O adapter 206 with a suitable wired communications media.

In one embodiment, network 106 may comprise a wireless network. In this case, I/O adapter 206 may comprise a wireless transmitter/receiver (“transceiver”). Transceiver 206 may be used to communicate monitoring information and control information between monitoring device 110 and another device, such as client device 104 or server 108, via network 106.

In one embodiment, transceiver 206 may comprise a transmitter and a receiver, either implemented alone or in combination. The transmitter may comprise any transmitter system configured to transmit an electromagnetic signal, such as a RF signal at a desired operating frequency. The transmitter may comprise a transmitter antenna operatively coupled to an output stage. The output stage may comprise various conventional driving and amplifying circuits, including a circuit to generate an electric current. When the electric current is supplied to the transmitter antenna, the transmitter antenna may generate electromagnetic signals around the transmitter antenna at the operating frequency. The receiver may comprise any receiver system configured to receive RF signals from a transmitter at a predetermined operating frequency. For example, the receiver may comprise conventional amplifying and signal-processing circuits, such as band pass filters, mixers, and amplifier circuits.

In one embodiment, transceiver 206 may use a number of different operating frequencies depending upon network 106 or a given implementation. For example, transceiver 206 may operate using any desired frequency band allocated for a conventional cellular network. In another example, transceiver 206 may also operate using any desired frequency band allocated for consumer electronics, such as frequency band within the 890-960 Megahertz (MHz) range, 1990-2110 MHz range, 2400-2500 MHz range, 5 Gigahertz (GHz), or other frequency ranges as approved by FCC regulations. The frequency bands for consumer electronics may be useful if system 100 is modified to allow client device 114 to connect to network 106, and client device 114 communicates the monitoring information to monitoring device 110 via an 802.11 network, for example. In any event, the selected frequency band should provide sufficient bandwidth to provide real time communications in accordance with a desired set of quality and latency parameters for a given implementation. The embodiments are not limited in this context.

In one embodiment, monitoring device 200 may include MMM 208. MMM 208 may receive the monitoring information from transceiver 206 via bus 218. MMM 208 may be arranged to analyze the monitoring information, select a status level corresponding to the monitoring information, and generate a status indicator signal corresponding to the status level. For example, MMM 208 may be configured with a first set of monitoring parameters. A monitoring parameter may include any parameter to measure a characteristic of the monitored person or the environment of the monitored person. For example, a monitoring parameter may include a number of times the monitored person enters a room, a length of time the monitored person remains in each room, a number of phone calls made by the monitored person, a number of hours a device such as an entertainment system or exercise equipment is activated, a temperature for a device or room, values indicating operation of a health system such as a heart monitor for the monitored person, a length of time a light source remains on, and so forth. The first set of monitoring parameters may be set to threshold values to represent a normal or baseline status level for the monitored person. MMM 208 may retrieve a second set of monitoring parameters from the monitoring information. The second set of monitoring parameters may comprise current values for the monitoring parameters. MMM 208 may compare the current values with the threshold values, and generate a status indicator signal in accordance with the comparison.

In one embodiment, various levels of difference between the current values and threshold values may correspond to status levels for the monitored person. The status levels may have any desired level of granularity. For example, assume a monitoring parameter includes a time period since the monitored person has moved between rooms, such as a bedroom and a kitchen. An example of status levels associated with this monitoring parameter may be illustrated using Table 1.

TABLE 1

| | Current | | | |
|---|---|---|---|---|
| Threshold Value | Value | Difference | Status Level | Indicator |
| 10 hours | 0-10 hours | 0 hour | Level 1 | Green Light |
| 10 hours | 11 hours | 1 hour | Level 2 | Yellow Light |
| 10 hours | 12 hours | 2 hours | Level 3 | Orange Light |
| 10 hours | 13 hours | 3 hours | Level 4 | Red Light, |
| | | | | Beep |

This monitoring parameter may assume that the monitored person typically does not spend more than 10 continuous hours in the bedroom (e.g., sleeping) before entering the kitchen. Assume a first sensor is placed in the bedroom and a second sensor in the kitchen. Both are active RFID sensors connected to motion detectors, such as motion detector 112. Whenever the monitored person wearing recording device 102 enters the bedroom, motion detector 112 detects movements within the bedroom, and sends a wake up signal to the first sensor. The first sensor begins continuously transmitting a first sensor identifier that is received by recording device 102. Recording device 102 starts a timer to measure the amount of time the first sensor identifier is received by recording device 102, and hence the current value representing an amount of time the monitored person has been in the bedroom. Alternatively, the first sensor may perform the timing operations and periodically send a time stamp to recording device 102. On a periodic basis, or in response to a signal from client device 104, recording device 102 may communicate the current value to client device 104. Client device forwards the current value to monitoring device 110 via network 106 and/or server 108. Transceiver 206 receives the current value, and sends it to MMM 208 via bus 218. MMM 208 may compare the current value with the threshold value. If the current value is less than the threshold value, in this example 10 hours, the status level may be set to status level 1. MMM 208 may generate a status indicator signal to represent status level 1. As the current value increases beyond the threshold value, however, there is a gradual increase or change in the status level from status level 1 to status level 4. MMM 208 may generate a status indicator signal to represent each status level, and send the status indicator signal to SIM 210.

In one embodiment, monitoring device 200 may include SIM 210. SIM 210 may include multiple status indicators. Examples of status indicators may include display 212 to display visual information, one or more LEDs to emit one or more colors, speaker 214 to reproduce audio information, a vibrating device, and so forth. Display 212 may comprise any type of display, such as a cathode ray tube (CRT) monitor, a flat screen monitor, a liquid crystal display (LCD), a plasma display, and so forth. The status indicators may include any type of visual, auditory, olfactory or sensory output devices, and the embodiments are not limited in this context.

SIM 210 may receive the status indicator signal, and indicate the current status level using the status indicator in response to the status indicator signal. For example, if the status indicator signal represents status level 1, SIM 210 may cause a LED to emit a green color to indicate normal status conditions. If the status indicator signal represents status level 2, SIM 210 may cause a LED to emit a yellow color to indicate a change in status conditions. This may continue through all the status levels, until SIM 210 causes a LED to emit a red color, and speaker 214 to reproduce audio information in the form of a tone or beeping sound. This may serve to alert the monitoring person that the monitored person may have been in the bedroom for an abnormal period of time, thereby causing the monitoring person to initiate some action such as attempting to contact the monitored person.

In one embodiment, monitoring device 102 may include alarm module 216. Alarm module 216 may send an alarm message in response to a change in status level if an acknowledgement message is not received within a predetermined time period. Once a change in status is indicated, MMM 208 may wait to receive an acknowledgement from the monitoring person. The monitoring person may send an acknowledgement message to indicate the change in status has been noticed. The acknowledgement message may be sent by pressing a button disposed on monitoring device 200, or by sending the acknowledgement message via the monitoring person's cell phone, for example. If an acknowledgement message is not received within a predetermined time period, an escalation operation may be initiated. The escalation operation may include sending an alarm message to a user device 1-P, such as a cell phone for the monitoring person via transceiver 206 or client device 114.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

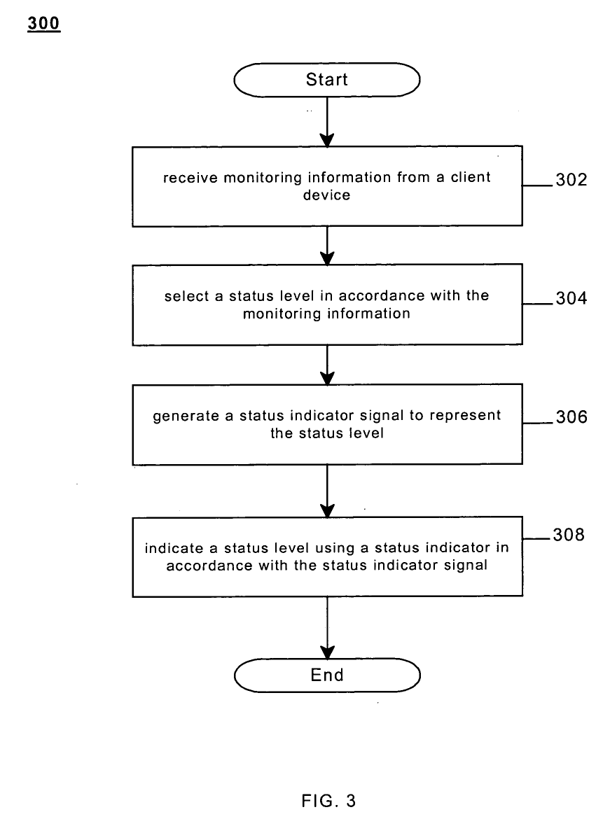

FIG. 3 illustrates a programming logic 300. FIG. 3 illustrates a programming logic 300 that may be representative of the operations executed by one or more systems described herein, such as systems 100 and/or 200. As shown in programming logic 300, monitoring information may be received from a client device at block 302. A status level may be selected in accordance with the monitoring information at block 304. A status indicator signal may be generated to represent the status level at block 306. The status level may be indicated using a status indicator in accordance with the status indicator signal at block 308. The status level may be indicated, for example, by displaying visual information and/or reproducing audio information.

In one embodiment, the status level may be selected at block 304 by retrieving a first set of monitoring parameters from memory. A second set of monitoring parameters may be retrieved from the monitoring information. The first and second sets of monitoring parameters may be compared. The status level may be selected in accordance with the results of the comparison.

In one embodiment, a determination may be made as to whether an acknowledgement message has been received in response to a change in the status level. An alarm message may be generated if the acknowledgement message is not received within a predetermined time period. The alarm message may be sent to a user device.

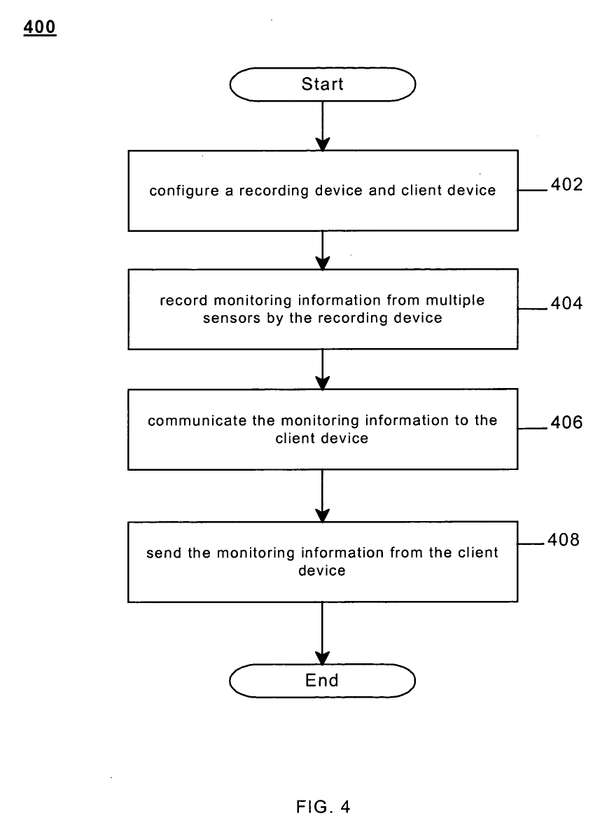

FIG. 4 illustrates a programming logic 400. FIG. 4 illustrates a programming logic 400 that may be representative of the operations executed by one or more systems described herein, such as systems 100 and/or 200. As shown in programming logic 400, a recording device may be configured at block 402. Monitoring information may be recorded from multiple sensors by a recording device at block 404. The monitoring information may be communicated to the client device at block 406. The monitoring information may be sent from the client device at block 408.

The operation of the above described systems and associated programming logic may be better understood by way of example. Assume the monitoring person and monitored person desire to subscribe to monitoring services so that the monitoring person may remotely monitor the monitored person. The monitored person may use client device 104 to subscribe to the monitoring services via server 108 as an information source. The monitored person may select a user name and password, provide user identifiers for those individuals (e.g., the monitoring person) authorized to access information about the monitored person, undergo authentication operations to confirm the identity of the monitored person, select monitoring parameters (e.g., pedometer readings, telephone calls, etc.) to be released to the authorized individuals, and so forth. Similarly, the monitoring person may use client device 114 to subscribe to the monitoring service via server 108 as an information consumer. The monitoring person may perform subscriber operations similar to the monitored person. In addition, the monitoring person may provide information regarding monitoring device 110, such as a network address, available status indicators, access numbers for user devices 1-P, and so forth.

Once the monitored person has subscribed to the monitoring services provided via server 108, the service provider may send a nominally configured recording device 102 implemented in the form of a watch or locket. The monitored person may complete the configuration operations for recording device 102 by testing whether recording device 102 can recognize the various sensors 1-N in the residence. The monitored person may come within communication range of client device 104 to allow recording device 102 and client device 104 to pair, and can check whether the monitoring information was downloaded to client device 104, the accuracy of the monitoring information, a list of recognized sensors, a list of monitoring parameters, and so forth. Once recording device 102 has been configured, recording device 102 is ready to begin normal operation.

Once the monitoring person has subscribed to the monitoring services provided via server 108, the service provider may send a nominally configured monitoring device 200 to the monitoring person. The monitoring person may test monitoring device 200 in a manner similar to recording device 102 to complete the configuration of monitoring device 200. For example, the monitoring person may configure a time interval between receiving monitoring information, set threshold values for monitoring parameters, set status levels, set status indicators, and so forth.

Once the first and monitored persons have finished configuring recording device 102 and monitoring device 200, the monitoring person may begin remote monitoring of the monitored person using the selected monitoring parameters, defined status levels, and status indicators.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

All or portions of an embodiment may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

1. An apparatus, comprising:
a receiver to receive monitoring information from a client device;
a monitoring management module to couple to said receiver, said monitoring management module to analyze said monitoring information, select a status level corresponding to said monitoring information, and generate a status indicator signal corresponding to said status level; and
a status indicating module having a status indicator, said status indicating module to receive said status indicator signal and to indicate said status level using said status indicator in response to said status indicator signal.

2. The apparatus of claim 1, wherein said status indicator comprises at least one of a display to display visual information, a light emitting diode to emit multiple colors, and a speaker to reproduce audio information.

3. The apparatus of claim 1, wherein said monitoring management module includes a first set of monitoring parameters, with said monitoring management module to retrieve a second set of monitoring parameters from said monitoring information and compare said first and second sets of monitoring parameters, and to generate said status indicator signal in accordance with said comparison.

4. The apparatus of claim 1, further comprising a recording device to couple to said client device, said recording device to record said monitoring information from multiple sensors and communicate said monitoring information to said client device, with said client device to send said monitoring information to said receiver.

5. The apparatus of claim 1, further comprising an alarm module to send an alarm message in response to a change in status level if an acknowledgement message is not received within a predetermined time period.

6. A system, comprising:
a client device to send monitoring information;
a monitoring device to indicate a status in response to said monitoring information, said monitoring device including:
an omnidirectional antenna;
a receiver to couple to said antenna, said receiver to receive said monitoring information from said client device;
a monitoring management module to couple to said receiver, said monitoring management module to analyze said monitoring information and generate a status indicator signal corresponding to a status level; and
a status indicating module having a status indicator, said status indicating module to receive said status indicator signal and to indicate said status level using said status indicator in response to said status indicator signal.

7. The system of claim 6, wherein said status indicator comprises at least one of a display to display visual information, a light emitting diode to emit multiple colors, and a speaker to reproduce audio information.

8. The system of claim 6, wherein said monitoring management module includes a first set of monitoring parameters, with said monitoring management module to retrieve a second set of monitoring parameters from said monitoring information and compare said first and second sets of monitoring parameters, and to generate said status indicator signal in accordance with said comparison.

9. The system of claim 6, further comprising a recording device to couple to said client device, said recording device to record said monitoring information from multiple sensors and communicates said monitoring information to said client device, with said client device to send said monitoring information to said receiver.

10. The system of claim 6, further comprising an alarm module to send an alarm message in response to a change in status level if an acknowledgement message is not received within a predetermined time period.

11. A method, comprising:
receiving monitoring information from a client device;
selecting a status level in accordance with said monitoring information;
generating a status indicator signal to represent said status level; and
indicating said status level using a status indicator in accordance with said status indicator signal.

12. The method of claim 11, wherein indicating said status comprises at least one of displaying visual information and reproducing audio information.

13. The method of claim 11, wherein said selecting comprises:
retrieving a first set of monitoring parameters from memory;
retrieving a second set of monitoring parameters from said monitoring information;
comparing said first and second sets of monitoring parameters; and
selecting said status level in accordance with said comparison.

14. The method of claim 11, further comprising:
determining whether an acknowledgement message has been received in response to a change in said status;
generating an alarm message if said acknowledgement message is not received within a predetermined time period; and
sending said alarm message to a user device.

15. The method of claim 11, further comprising:
recording monitoring information from multiple sensors by a recording device;
communicating said monitoring information to said client device; and
sending said monitoring information from said client device.

16. An article comprising:
a storage medium;
said storage medium including stored instructions that, when executed by a processor, are operable to receive monitoring information from a recording device, select a status level in accordance with said monitoring information, generate a status indicator signal to represent said status level, and indicate said status level using a status indicator in accordance with said status indicator signal.

17. The article of claim 16, wherein the stored instructions, when executed by a processor, perform said indication using stored instructions operable to display visual information or reproduce audio information.

18. The article of claim 16, wherein the stored instructions, when executed by a processor, perform said selection using stored instructions operable to retrieve a first set of monitoring parameters from memory, retrieve a second set of monitoring parameters from said monitoring information, compare said first and second sets of monitoring parameters, and select said status level in accordance with said comparison.

19. The article of claim 16, wherein the stored instructions, when executed by a processor, are further operable to determine whether an acknowledgement message has been received in response to a change in said status, generate an alarm message if said acknowledgement message is not received within a predetermined time period, and send said alarm message to a user device.

20. The article of claim 16, wherein the stored instructions, when executed by a processor, are further operable to record monitoring information from multiple sensors by a recording device, communicate said monitoring information to said client device, and send said monitoring information from said client device.
